(19) United States
(12) Patent Application Publication
(10) Pub. No.: US 2013/0180080 A1
(43) Pub. Date: Jul. 18, 2013

(54) Castor Having Waterproof Function

(71) Applicant: Po-Chuan Tsai, Rende Hsian (TW)

(72) Inventor: Po-Chuan Tsai, Rende Hsian (TW)

(21) Appl. No.: 13/351,019

(22) Filed: Jan. 16, 2012

(51) Int. Cl. B60B 33/00

(52) U.S. Cl. 16/43

(57) ABSTRACT

A castor includes a castor body, a waterproof gasket, a bearing, a top cover, a shaft, a bushing, a washer, and a snap ring. The castor body has a receiving recess to receive the waterproof gasket and the bearing. The top cover is mounted on the castor body to cover the waterproof gasket and the bearing. The waterproof gasket is located between the castor body and the bearing and has a sealing flange. Thus, the sealing flange of the waterproof gasket is disposed between the top cover and the castor body to isolate the bearing completely, so that even when the castor touches water unintentionally, the water cannot contact the bearing, thereby preventing the bearing from being rusted or worn out so as to enhance the lifetime of the bearing of the castor.

### BACKGROUND OF THE INVENTION

1. Field of the Invention

The present invention relates to a castor and, more particularly, to a castor for a wheeled vehicle, such as chair, cart and the like.

2. Description of the Related Art

A conventional castor 1 in accordance with the prior art shown in FIGS. 4 and 5 comprises a castor body 10, a spacer 11, a bearing 12, a top cover 13, a shaft 14, a bushing 15, a washer 16, and a snap ring 17. The castor body 10 has an upper portion provided with a receiving recess 101 to receive the spacer 11 and the bearing 12. The spacer 11 is mounted in the receiving recess 101 of the castor body 10 and is located between the castor body 10 and the bearing 12. The bearing 12 is located between the spacer 11 and the shaft 14. The top cover 13 is mounted on the upper portion of the castor body 10 to cover the spacer 11 and the bearing 12. The bushing 15 has a substantially inverted T-shaped cross-sectional profile. The bushing 15 is mounted on the castor body 10 and located between the castor body 10 and the shaft 14. The shaft 14 has a lower end 141 in turn extended through the top cover 13, the bearing 12, the castor body 10 and the bushing 15. The lower end 141 of the shaft 14 has a distal portion provided with a retaining portion 142 extended through and protruded outward from the washer 16. The washer 16 is mounted on the retaining portion 142 of the shaft 14 and abuts the bottom of the bushing 15. The snap ring 17 is snapped onto the retaining portion 142 of the shaft 14 and abuts the bottom of the washer 16. However, a clearance is formed between the spacer 11, the bearing 12 and the top cover 13, so that the bearing 12 is not covered and sealed completely. Thus, when water touches the castor unintentionally, the water will permeate through the clearance between the spacer 11, the bearing 12 and the top cover 13 and will directly contact the bearing 12 so that the bearing 12 is dusted or worn out due to the water and cannot be moved smoothly and stably, thereby easily causing the castor 1 inoperative.

### BRIEF SUMMARY OF THE INVENTION

In accordance with the present invention, there is provided a castor, comprising a castor body, a waterproof gasket, a bearing, a top cover, a shaft, a bushing, a washer, and a snap ring. The castor body has an upper portion provided with a receiving recess to receive the waterproof gasket and the bearing. The castor body has a lower portion provided with a receiving hole to receive the bushing. The top cover is mounted on the upper portion of the castor body to cover the waterproof gasket and the bearing. The top cover has a central portion provided with a through bore to allow passage of the shaft. The waterproof gasket is mounted in the receiving recess of the castor body and is located between the castor body and the bearing. The waterproof gasket has a central portion provided with a mounting hole for mounting the bearing. The waterproof gasket has a top provided with a sealing flange. The sealing flange of the waterproof gasket is disposed between the top cover and the castor body and has a top face abutting a bottom face of the top cover and a bottom face abutting a top face of the castor body so as to eliminate a clearance between the top cover and the castor body and to isolate the bearing. The bearing has a central portion provided with a through hole to allow passage of the shaft. The bushing has a central portion provided with a through aperture to allow passage of the shaft. The shaft has a lower end in turn extended through the through bore of the top cover, the through hole of the bearing, the receiving hole of the castor body and the through aperture of the bushing. The lower end of the shaft has a distal portion provided with a recessed retaining portion extended through and protruded outward from the washer. The washer is mounted on the retaining portion of the shaft and abuts a bottom of the bushing. The snap ring is snapped onto the retaining portion of the shaft and abuts a bottom of the washer.

The primary objective of the present invention is to provide a castor having a waterproof function.

According to the primary advantage of the present invention, the sealing flange of the waterproof gasket is disposed between the top cover and the castor body to provide a waterproof function between the top cover and the castor body and to isolate the bearing completely, so that even when the castor touches water unintentionally, the water is isolated and cannot contact the bearing, thereby preventing the bearing from being rusted or worn out so as to enhance the lifetime of the bearing of the castor.

According to another advantage of the present invention, the bearing will not be rusted so that the bearing is moved smoothly and stably during a long-term utilization, thereby facilitating the user operating the castor.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a castor in accordance with the preferred embodiment of the present invention.

FIG. 2 is an exploded perspective view of the castor as shown in FIG. 1.

FIG. 3 is a front cross-sectional view of the castor as shown in FIG. 1.

FIG. 4 is an exploded perspective view of a conventional castor in accordance with the prior art.

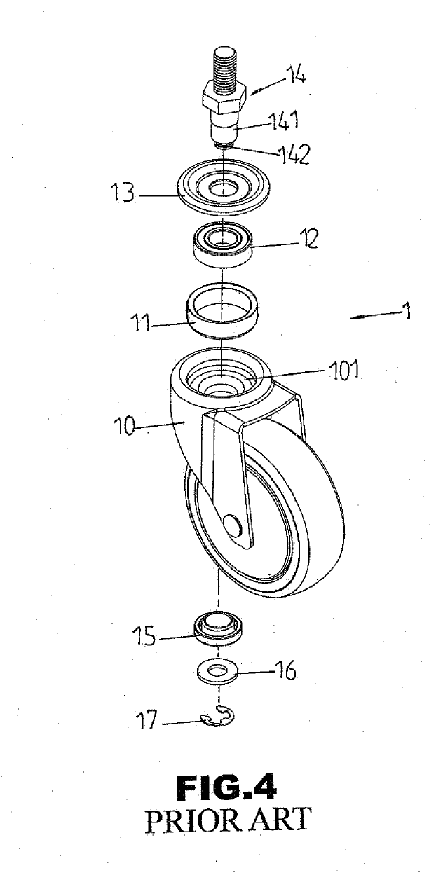

FIG. 5 is a front cross-sectional assembly view of the conventional castor as shown in FIG. 4.

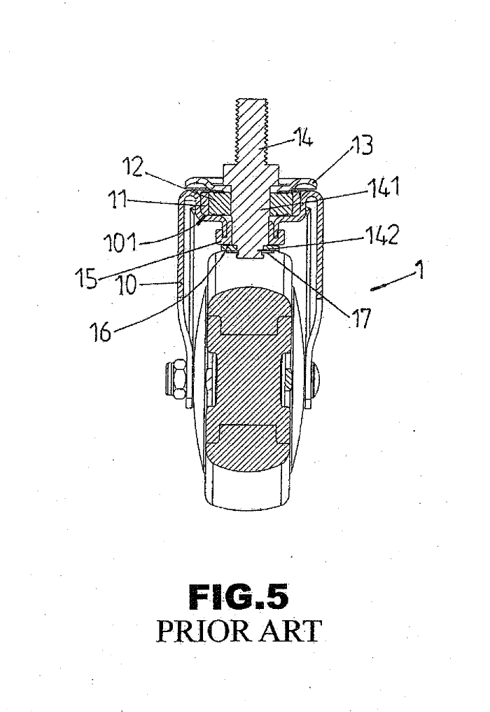

### DETAILED DESCRIPTION OF THE INVENTION

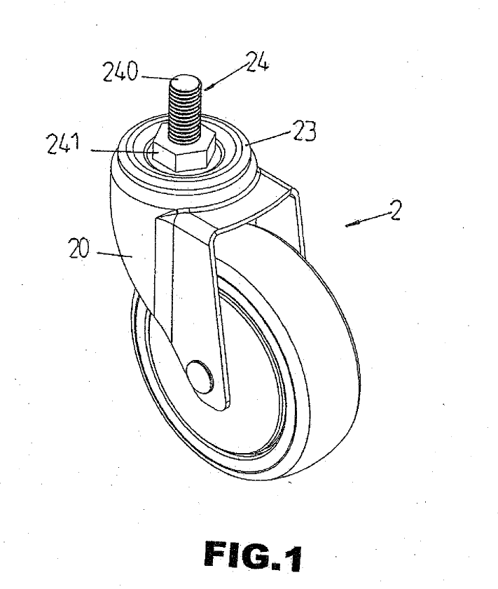

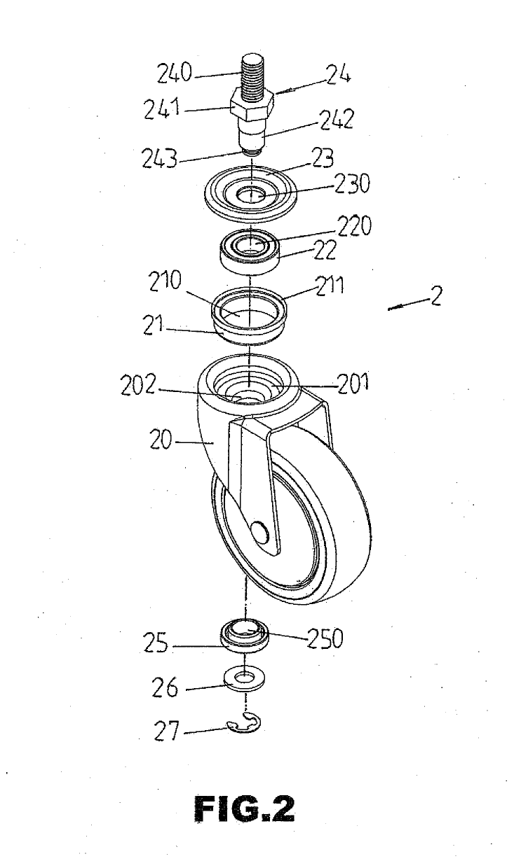

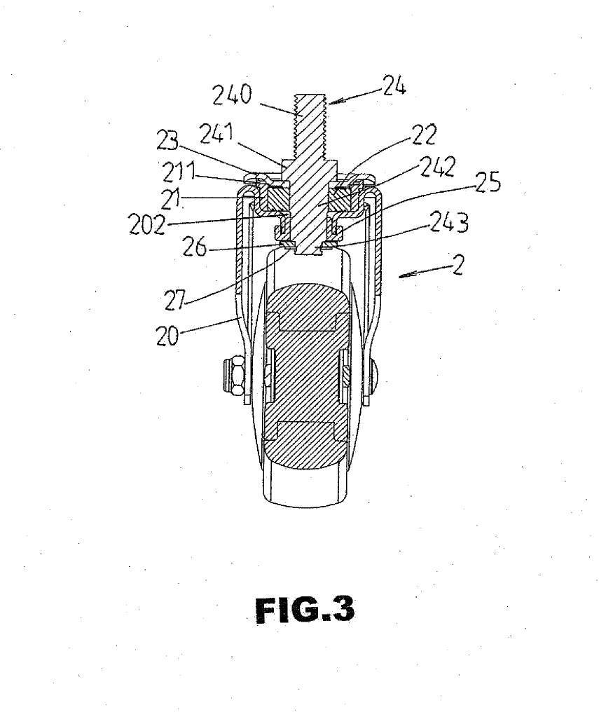

Referring to FIGS. 1-3, a castor 2 in accordance with the preferred embodiment of the present invention comprises a castor body 20, a waterproof gasket 21, a bearing 22, a top cover 23, a shaft 24, a bushing 25, a washer 26, and a snap ring 27.

The castor body 20 has an upper portion provided with a receiving recess 201 to receive the waterproof gasket 21 and the bearing 22. The castor body 20 has a lower portion provided with a receiving hole 202 to receive the bushing 25. The receiving hole 202 of the castor body 20 is connected to and has a diameter smaller than that of the receiving recess 201. The receiving hole 202 of the castor body 20 is located at a central portion of the receiving recess 201.

The waterproof gasket 21 is mounted in the receiving recess 201 of the castor body 20 and is located between the castor body 20 and the bearing 22. Thus, when the castor body 20 and the bearing 22 are combined, the waterproof gasket 21 has a size calibration and noise elimination function. The waterproof gasket 21 has a central portion provided with a mounting hole 210 for mounting the bearing 22.

The waterproof gasket 21 has a top provided with a sealing flange 211. The sealing flange 211 of the waterproof gasket 21 has a substantially inverted L-shaped cross-sectional profile. The sealing flange 211 of the waterproof gasket 21 is disposed between the top cover 23 and the castor body 20 and has a top face abutting a bottom face of the top cover 23 and a bottom face abutting a top face of the castor body 20 so as to eliminate a clearance between the top cover 23 and the castor body 20 and to isolate the bearing 22.

The bearing 22 is located between the waterproof gasket 21 and the shaft 24. The bearing 22 has a central portion provided with a through hole 220 to allow passage of the shaft 24.

The top cover 23 is made of iron. The top cover 23 is mounted on the upper portion of the castor body 20 to cover the waterproof gasket 21 and the bearing 22. The top cover 23 has a central portion provided with a through bore 230 to allow passage of the shaft 24.

The bushing 25 has a substantially inverted T-shaped cross-sectional profile. The bushing 25 has a central portion provided with a through aperture 250 to allow passage of the shaft 24. The bushing 25 is mounted on the castor body 20 and located between the castor body 20 and the shaft 24 to eliminate a noise produced during a relative movement between the castor body 20 and the shaft 24. The bushing 25 is partially inserted into the receiving hole 202 of the castor body 20 and partially protruded outward from the receiving hole 202 of the castor body 20. The bushing 25 abuts a bottom wall of the receiving hole 202 of the castor body 20.

The shaft 24 has a lower end 242 in turn extended through the through bore 230 of the top cover 23, the through hole 220 of the bearing 22, the receiving hole 202 of the castor body 20 and the through aperture 250 of the bushing 25. The lower end 242 of the shaft 24 has a distal portion provided with a recessed retaining portion 243 extended through and protruded outward from the washer 26. The shaft 24 has an upper end provided with an external thread 240. The shaft 24 has a mediate portion provided with an enlarged stop shoulder 241 abutting a top of the top cover 23. The stop shoulder 241 of the shaft 24 is located between the external thread 240 and the lower end 242 of the shaft 24.

The washer 26 is mounted on the retaining portion 243 of the shaft 24 and abuts a bottom of the bushing 25.

The snap ring 27 is snapped onto the retaining portion 243 of the shaft 24 and abuts a bottom of the washer 26.

In use, when water is sprayed or dropped onto the castor 2, the sealing flange 211 of the waterproof gasket 21 is sealed between the top cover 23 and the castor body 20 to provide a waterproof function between the top cover 23 and the castor body 20 and to isolate the bearing 22 completely, thereby preventing the water from directly contacting the bearing 22, and thereby preventing the bearing 22 from being rusted or worn out so as to enhance the lifetime of the bearing 22.

Accordingly, the sealing flange 211 of the waterproof gasket 21 is disposed between the top cover 23 and the castor body 20 to provide a waterproof function between the top cover 23 and the castor body 20 and to isolate the bearing 22 completely, so that even when the castor 2 touches water unintentionally, the water is isolated and cannot contact the bearing 22, thereby preventing the bearing 22 from being rusted or worn out so as to enhance the lifetime of the bearing 22 of the castor 2. In addition, the bearing 22 will not be rusted so that the bearing 22 is moved smoothly and stably during a long-term utilization, thereby facilitating the user operating the castor 2.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A castor, comprising:
a castor body, a waterproof gasket, a bearing, a top cover, a shaft, a bushing, a washer, and a snap ring;
wherein the castor body has an upper portion provided with a receiving recess to receive the waterproof gasket and the bearing;
the castor body has a lower portion provided with a receiving hole to receive the bushing;
the top cover is mounted on the upper portion of the castor body to cover the waterproof gasket and the bearing;
the top cover has a central portion provided with a through bore to allow passage of the shaft;
the waterproof gasket is mounted in the receiving recess of the castor body and is located between the castor body and the bearing;
the waterproof gasket has a central portion provided with a mounting hole for mounting the bearing;
the waterproof gasket has a top provided with a sealing flange;
the sealing flange of the waterproof gasket is disposed between the top cover and the castor body and has a top face abutting a bottom face of the top cover and a bottom face abutting a top face of the castor body so as to eliminate a clearance between the top cover and the castor body and to isolate the bearing;
the bearing has a central portion provided with a through hole to allow passage of the shaft;
the bushing has a central portion provided with a through aperture to allow passage of the shaft;
the shaft has a lower end in turn extended through the through bore of the top cover, the through hole of the bearing, the receiving hole of the castor body and the through aperture of the bushing;
the lower end of the shaft has a distal portion provided with a recessed retaining portion extended through and protruded outward from the washer;
the washer is mounted on the retaining portion of the shaft and abuts a bottom of the bushing;
the snap ring is snapped onto the retaining portion of the shaft and abuts a bottom of the washer.
